(19) United States
(12) Patent Application Publication
(10) Pub. No.: US 2015/0171487 A1
(43) Pub. Date: Jun. 18, 2015

(54) MONITORING UNIT AND MONITORING DEVICE OF BATTERY PACK

(71) Applicant: DENSO CORPORATION, Kariya-city (JP)

(72) Inventors: Masaya ITOU, Toyota-shi (JP); Shunichi MIZOBE, Kariya-shi (JP)

(21) Appl. No.: 14/564,257

(22) Filed: Dec. 9, 2014

(30) Foreign Application Priority Data
Dec. 12, 2013 (JP) 2013-256865

(51) Int. Cl. H01M 10/48

(52) U.S. Cl. CPC H01M 10/482

(57) ABSTRACT

A monitoring device has a control unit and monitoring units. A substrate of each monitoring unit has a high voltage section and a low voltage section. A cell monitoring IC detects a state of battery cells in the battery pack and is mounted in the high voltage side in a substrate of each monitoring unit. A photocoupler or capacitor is arranged between an input connector and the cell monitoring IC of each monitoring unit. A photocoupler or capacitor is arranged between an output connector of the substrate and the cell monitoring IC. The cell monitoring IC receives an input signal through the input connector and the photocoupler or capacitor, and transmits an output signal to the other monitoring unit or the control unit through the photocoupler or capacitor and the output connector.

### CROSS-REFERENCE TO RELATED APPLICATION

This application is related to and claims priority from Japanese Patent Application No. 2013-256865 filed on Dec. 12, 2013, the contents of which are hereby incorporated by reference.

### BACKGROUND OF THE INVENTION

1. Field of the Invention

The present invention relates to monitoring units and monitoring devices capable of monitoring a state of a plurality of battery cells in a battery pack.

2. Description of the Related Art

Hybrid vehicles use various types of battery packs. Such a battery pack is usually constructed by a plurality of battery cells connected in series in order to supply a high voltage power. A repetition of charging and discharging the battery pack causes variation of a different charged state of the battery cells. In order to prevent and decrease a difference in a charged state between the battery cells, it is necessary to monitor the charged state of each of the battery cells. Various monitoring devices haven been proposed for detecting a voltage of each of the battery cells in the battery pack.

For example, a patent document, Japanese patent laid open publication No. 2011-53179, shows a conventional technique in which battery cells are divided into several blocks or groups, and cell monitoring integrated circuits (cell monitoring ICs) are arranged for the blocks of the battery cells, respectively. That is, each of the monitoring ICs detects the corresponding block of the battery cells. Further, a main microcomputer receives the detection signals transmitted from the cell monitoring ICs and performs control operations on the basis of the received detection signals. The main microcomputer and the cell monitoring ICs are connected in a daisy chain connection.

In the conventional monitoring device having the structure previously described, it is possible to mount each of the cell monitoring ICs to a different substrate in order to make a function distribution structure. In particular, the cell monitoring IC is arranged in a high voltage section of the monitoring unit. This structure requires communication lines to connect the substrate having the cell monitoring IC and the substrate having the microcomputer through connectors. However, there is a drawback that a high voltage of the cell monitoring IC is supplied to the connector mounted on the substrate having the next monitoring IC or the substrate having the microcomputer. For such a reason, when the connectors of the substrate having the cell monitoring ICs are disconnected from each other, or one substrate having one cell monitoring IC is disconnected from another substrate having another cell monitoring IC, or the substrates having the cell monitoring ICs are connected together during a maintenance work, there is in danger of electric shock when an operator touches and is in contact with the high-voltage charged connecter.

### SUMMARY

It is therefore desired to provide a battery device having a control unit and monitoring units capable of monitoring a state of a battery pack composed of battery cells. The monitoring units and the control unit are electrically connected together through input connectors, output connectors and communication wires. Each of the monitoring units has a cell monitoring IC capable of detecting a state of battery cells in the battery pack. In particular, each of the monitoring units is a safety connectable and detachable unit without causing danger of electric shock.

An exemplary embodiment provides a monitoring unit capable of monitoring a state of a battery pack. The monitoring unit has a substrate, a battery state detection section, an input side connection and disconnection section, an output side connection and disconnection section, an input side isolation element and an output side isolation element. The substrate has a high voltage section and a low voltage section. The battery state detection section is mounted in the high voltage side of the substrate and configured to detect a state of the battery pack comprising a plurality of battery cells. The input side connection and disconnection section is mounted in the low voltage section of the substrate and configured to connect an input signal line to an outside signal line, and disconnect the input signal line from the outside signal line, the battery state detection sections receiving an input signal through the input signal line, and the outside signal line being arranged outside of the substrate. The output side connection and disconnection section is mounted in the low voltage section of the substrate and configured to connect an output signal line to the outside signal line and disconnect the output signal line from the outside signal line, the battery state detection section outputting an output signal to the outside signal line through the output signal line. The input side isolation element is mounted on the substrate and configured to transmit the input signal from the input signal line to the battery state detection section under an electrical insulation state. The output side isolation element is mounted on the substrate and configured to transmit the output signal from the battery state detection section to the output signal line under the electrical insulation state.

Further, the exemplary embodiment provides a monitoring device which monitors a state of a battery pack. The monitoring device has a plurality of the monitoring units previously described. The output side connection and disconnection section of a first monitoring unit is connected to the input side connection and disconnection section of a second monitoring unit when the first monitoring unit and the second monitoring unit are selected from the monitoring units.

In the structure of the monitoring unit and the monitoring device according to the exemplary embodiment, the battery state detection section is mounted in the high voltage section of the substrate of the monitoring unit. Further, the input side connection and disconnection section such as an input connector and the output side connection and disconnection section such as an output connector are mounted in the low voltage section of the substrate of the monitoring unit. The input side connection and disconnection section connects the input signal line and the outside signal line, and disconnects the input signal line from the outside signal line. The output side connection and disconnection section connects the output signal line and the outside signal line and disconnects the output signal line from the outside signal line. The battery state detection section is electrically insulated from the input side connection and disconnection section by the input side isolation element such as a photocoupler or a capacitor. Further, the battery state detection section is electrically insulated from the output side connection and disconnection section by the output side isolation element such as a photocoupler or a capacitor.

This structure prevents a high voltage of the battery state detection section such as a cell monitoring integrated circuit (cell monitoring IC) from being supplied to the input side connection and disconnection section and the output side connection and disconnection section by the input side isolation element and the output side isolation element. It is accordingly possible for an operator or a worker to avoid danger of electric shock when the operator touches and is in contact with the input side connection and disconnection section or the output side connection and disconnection section. The operator connects one monitoring unit from the control unit or the other monitoring unit safely and disconnects one monitoring from the control unit or the other monitoring unit safety without causing electric shock.

### BRIEF DESCRIPTION OF THE DRAWINGS

A preferred, non-limiting embodiment of the present invention will be described by way of example with reference to the accompanying drawings, in which:

FIG. 1 is a view showing a structure of a monitoring device equipped with monitoring units and a control unit, each of the monitoring units having cell monitoring IC according to an exemplary embodiment of the present invention;

FIG. 2 is a view showing another structural modification of the monitoring unit equipped with the cell monitoring IC in the monitoring device according to the exemplary embodiment of the present invention; and

FIG. 3 is a view showing another structural modification of the monitoring unit equipped with the cell monitoring IC in the monitoring device according to the exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

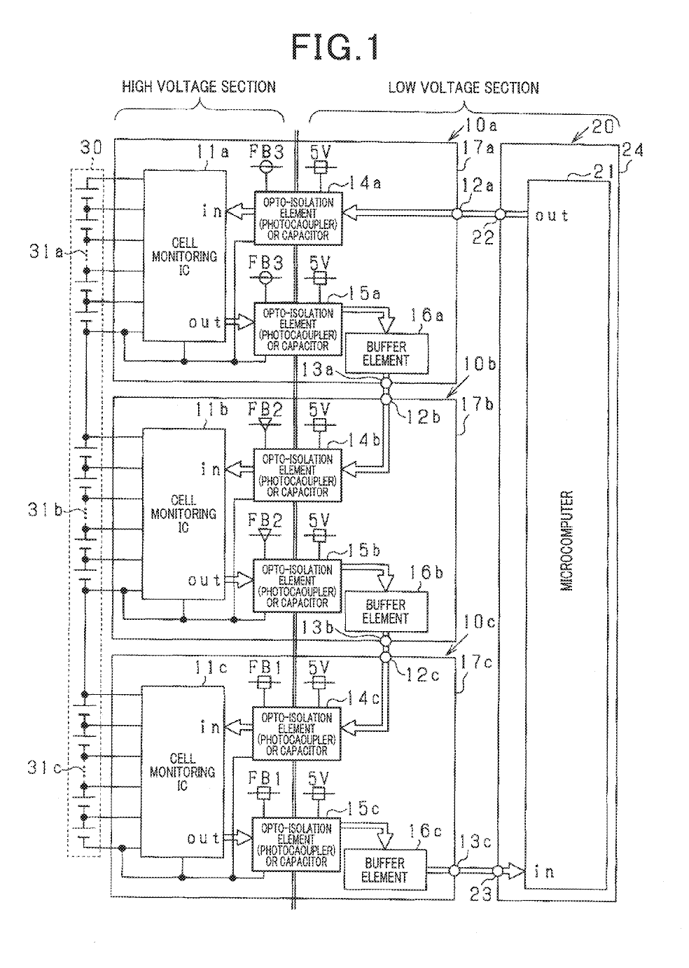

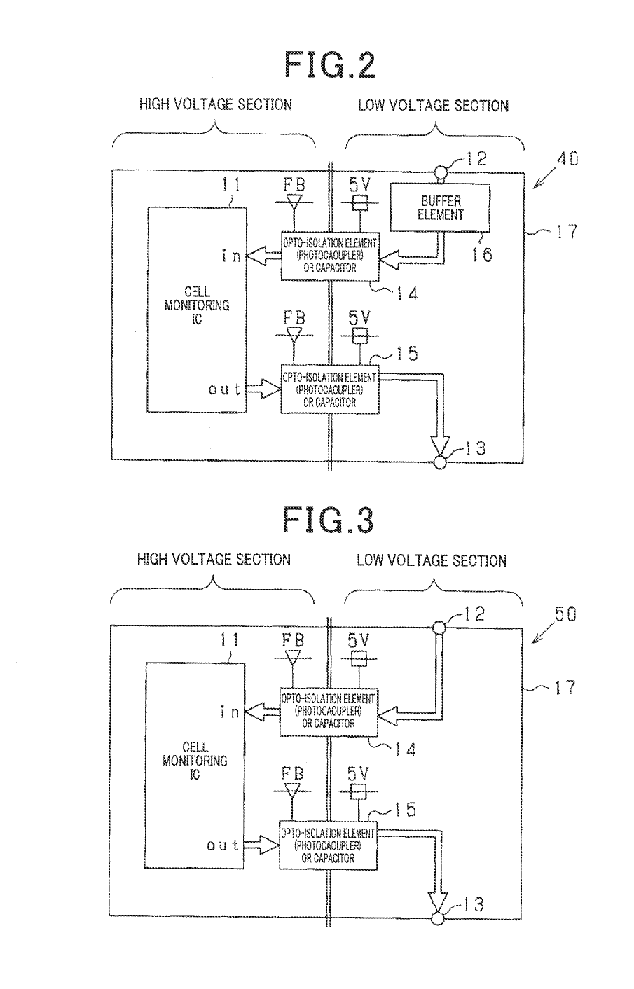

A description will be given of a monitoring device for monitoring a state of a battery pack according to an exemplary embodiment with reference to FIG. 1, FIG. 2 and FIG. 3.

FIG. 1 is a view showing a structure of the monitoring device equipped with the monitoring units 10a, 10b and 10c and a control unit 20 capable of monitoring a state of the battery pack 30 according to the exemplary embodiment. As shown in FIG. 1, the monitoring device according to the exemplary embodiment is equipped with the control unit 20 and the monitoring units 10a, 10band 10c. The monitoring device according to the exemplary embodiment monitors a state of the battery pack 30. The battery pack 30 is composed of a plurality of battery cells connected in series in order to supply a high voltage power. The battery units are divided into three cell blocks 31a, 31b and 31c.

The control unit 20 is mounted on a control substrate 24 and is equipped with a microcomputer 21 (as a control section), an output connector 22 (as an output control connection and disconnection section), and an input connector 23 (as an input control connection and disconnection section). The control unit 20 controls the operation of the monitoring units 10a, 10b and 10c.

The microcomputer 21 is a computer available in the commercial market. The microcomputer 21 is equipped with a central processing unit (CPU), a memory section and an input/output interface (I/O interface), etc. The microcomputer 21 is mounted on a control substrate 24. When receiving electric power supplied from a low voltage power source, the microcomputer 21 starts to operate and controls the operation of the monitoring units 10a, 10b and 10c. In more detail, the microcomputer 21 generates and transmits a start instruction signal to each of the monitoring units 10a, 10b and 10c. Each of the monitoring units 10a, 10b and 10c receives the start instruction signal transmitted from the microcomputer 21 and starts to detect a voltage of each of the battery cells. Each of the monitoring units 10a, 10b and 10c transmits a voltage signal regarding a detected voltage value to the microcomputer 21. The microcomputer 21 receives the voltage signals transmitted from each of the monitoring units 10a, 10b and 10c.

As shown in FIG. 1, the output connector 22 of the control unit 20 is mounted on the control substrate 24. The output connector 22 of the control unit 20 connects an output control signal line to an outside signal line. The outside signal line is arranged outside of the control substrate 24. The output connector 22 of the control unit 20 also disconnects the output control signal line from the outside signal line. The outside signal line is connected to the input connector 12a of the monitoring unit 10a.

As shown in FIG. 1, the input connector 23 of the control unit 20 is also mounted on the control substrate 24. The input connector 23 of the control unit 20 connects an input control signal line to an outside signal line. This outside signal line is arranged outside of the control substrate 24. That is, the outside signal line is also connected to the output connector 13c of the monitoring unit 10c.

The input connector 23 of the control unit 20 disconnects the input control signal line from the outside signal line.

The monitoring unit 10a is equipped with a substrate 17a, a cell monitoring integrated circuit (cell monitoring IC) 11a, the input connector 12a, an output connector 13a, an input side opto-isolation element (photocoupler) 14a as an input side isolation element, an output side opto-isolation element (photocoupler) 15a as an output side isolation element, and a buffer element 16a. Similar to the monitoring unit 10a, the monitoring unit 10b is equipped with s substrate 17b, a cell monitoring integrated circuit (cell monitoring IC) 11b, an input connector 12b, an output connector 13b, an input side opto-isolation element (photocoupler) 14b, an output side opto-isolation element (photocoupler) 15b , and a buffer element 16b. As with the monitoring units 10a and 10b, the monitoring unit 10c is equipped with s substrate 17c, a cell monitoring integrated circuit (cell monitoring IC) 11c, an input connector 12c, an output connector 13c, an input side opto-isolation element (photocoupler) 14c, an output side opto-isolation element (photocoupler) 15c, and a buffer element 16c.

That is, each of the opto-isolation elements 14a, 14b, 14c, 15a, 15b and 15c is a component that transfers electrical signals between two isolated circuits by using light. The opto-isolation element prevents a high voltage from affecting a system receiving a signal. The main function of such an opto-isolation element is to block high voltages and voltage transients, so that a surge in one part of a system will not disrupt or destroy the other parts.

The monitoring units 10a, 10b and 10c monitors a state of the cell blocks 31a, 31b and 131c, respectively. In the structure of the monitoring device according to the exemplary embodiment, the battery cells in the battery pack 30 are divided to three cell blocks. The three monitoring units 10a, 10b and 10c monitor the three cell blocks, respectively. However, the concept of the present invention is not limited by this structure. It is possible to divide the battery cells in the battery pack 30 to several cell groups other than the three cell groups and use several monitoring units corresponding to the number of the cell groups.

Each of the substrates 17a, 17b and 17c is equipped with a high voltage section and a low voltage section. The high voltage section is arranged at the battery pack 30 side and the low voltage section arranged at the control unit 20 side in each of the substrates 17a, 17b and 17c.

The cell monitoring IC 11a is mounted on the high voltage side of the substrate 17a. The cell monitoring IC 11b is also mounted on the high voltage side of the substrate 17b. Similarly, the cell monitoring IC 11c is mounted on the high voltage side of the substrate 17c. Each of the cell monitoring ICs 11a, 11b and 11c corresponds to a battery state detection section. When receiving electric power from the blocks 31a, 31b and 31c of the battery pack 30, each of the cell monitoring ICs 11a, 11b and 11c detects a voltage of each battery cell in the corresponding cell blocks 31a, 31b and 31c. In more detail, each of the cell monitoring ICs 11a, 11b and 11c is equipped with a cell voltage input section, a multiplexer, an A/D converter, etc. The cell voltage input section, the multiplexer and the A/D converter unit are omitted from the drawings for brevity. The cell voltage input section in each of the cell monitoring ICs 11a, 11b and 11c is electrically connected to a positive electrode and a negative electrode of each of the battery cells, and detects a voltage between the positive electrode and the negative electrode of the battery cell. The multiplexer in each of the cell monitoring ICs 11a, 11b and 11c receives a voltage detection signal transmitted from the cell voltage input section, and converts the received voltage detection signal to time series signals. The A/D converter unit receives the time series signals transmitted from the multiplexer and converts them to digital signals.

The input connectors 12a, 12b and 12c (which correspond to input side connection and disconnection sections) of the monitoring units 10a, 10b and 10c are mounted on the substrates 17a, 17b and 17c, respectively. In more detail, the input connector 12a is arranged in the low voltage section of the substrate 17a of the monitoring unit 10a. The input connector 12b is arranged in the low voltage section of the substrate 17b of the monitoring unit 10b. Similarly, the input connector 12c is arranged in the low voltage section of the substrate 17c of the monitoring unit 10c.

The input connectors 12a, 12b and 12c connect the input signal lines and the outside signal lines, and disconnect the input signal lines from the outside signal lines. Various signals are transmitted to the cell monitoring ICs 11a, 11b and 11c through the input signal lines. The outside signal lines located outside of the substrates 17a, 17b and 17c.

The output connectors 13a, 13b and 13c (which correspond to output side connection and disconnection sections) are mounted on the substrates 17a, 17b and 17c, respectively. In more detail, the output connector 13a is arranged in the low voltage section of the substrate 17a. The output connector 13b is arranged in the low voltage section of the substrate 17b. Similarly, the output connector 13c is arranged in the low voltage section of the substrate 17c.

The output connectors 13a, 13b and 13c connect the output signal lines and the outside signal lines, and disconnect the output signal lines from the outside signal lines. Various signals are outputted from the cell monitoring ICs 11a, 11b and 11c through the output signal lines. The outside signal lines are located outside of the substrates 17a, 17b and 17c.

As shown in FIG. 1, the output connector 22 of the control unit 20 is connected to the input connector 12a of the monitoring unit 10a through a wire harness (or a cable harness, not shown) of the substrate 17a. The wire harness is an assembly of wires, which transmit signals and electric power, arranged between the substrate 17a and the control substrate 24. The output connector 13c of the monitoring unit 10c is connected to the input connector 23 of the control unit 20 through a wire harness arranged between the substrate 17c and the control substrate 24. Further, the output connector 13a of the monitoring unit 10a (which corresponds to a first monitoring unit) is connected to th input connector 12b of the monitoring unit 10b (which corresponds to a second monitoring unit) through a wire harness arranged between the substrate 17a and the substrate 17b. Still further, the output connector 13b of the monitoring unit 10b is connected to the input connector 12c of the monitoring unit 10c (which corresponds to the second monitoring unit) through a wire harness arranged between the substrate 17b and the substrate 17c. Through the wire harnesses the control unit 20 and the monitoring units 10a, 10b and 10c are connected in a daisy chain connection.

When the cell monitoring IC 11a is electrically connected to the input connector 12a in the monitoring unit 10a, there is a possible power transmission of a high voltage of the cell monitoring IC 11a to the input connector 12a of the monitoring unit 10a and the output connector 22 of the control unit 20. For this reason, there is a possible danger of electric shock when an operator or worker touches and is in contact with the input connector 12a of the monitoring unit 10a or the output connector 22 of the control unit 20 in order to connect the substrate 17a to the control substrate 24, or disconnect and detach the substrate 17a from the control substrate 24.

Similarly, when the cell monitoring IC 11c is electrically connected to the output connector 13c in the monitoring unit 10c, there is a possible power transmission of a high voltage of the cell monitoring IC 11c to the output connector 13c of the monitoring unit 10c and the input connector 23 of the control unit 20. For this reason, there is a possible danger of electric shock when an operator touches and is in contact with the output connector 13c of the monitoring unit 10c or the input connector 23 of the control unit 20 in order to connect the substrate 17c to the control substrate 24 or disconnect and detach the substrate 17c from the control substrate 24.

Further, when the cell monitoring IC 11b and the cell monitoring IC 11c are electrically connected to the input connector 12b of the monitoring unit 10b and the input connector 12c of the monitoring unit 10c, respectively, there is a possible power transmission of a high voltage of the cell monitoring ICs 11b and the cell monitoring IC 11c to the input connector 12b of the monitoring unit 10b, the output connector 13a of the monitoring unit 10a, the input connector 12c of the monitoring unit 10c and the output connector 13b of the monitoring unit 10c.

Still further, when the cell monitoring IC 11a of the monitoring unit 10a and the cell monitoring IC 11b of the monitoring unit 10b are electrically connected to the output connector 13a of the monitoring unit 10a and the output connector 13b of the monitoring unit 10b, respectively, there is a possible power transmission of a high voltage of the cell monitoring ICs 11a and the cell monitoring IC 11b to the output connector 13a of the monitoring unit 10a, the input connector 12b of the monitoring unit 10b, the output connector 13b of the monitoring unit 10b and the input connector 12c of the monitoring unit 10c.

For this reason, there is a possible danger of electric shock when an operator touches and is in contact with the input connectors 12b and 12c and the output connectors 13a and 13b.

In order to avoid this possible danger of electric shock, in the improved structure of the monitoring units 10a, 10b and 10c in the monitoring device according to the exemplary embodiment, the input side opto-isolation elements 14a, 14b and 14c (as the input side isolation elements) are arranged between the cell monitoring ICs 11a, 11b and 11c and the input connectors 12a, 12b and 12c, respectively, and the output side opto-isolation elements 15a, 15b and 15c (as the output side isolation elements) are arranged between the cell monitoring ICs 11a, 11b and 11c and the output connectors 13a, 13b and 13c, respectively.

That is, this structure of the monitoring units 10a, 10b and 10c makes it possible to transmit signals from the input connectors 12a, 12b and 12c to the cell monitoring ICs 11a, 11b and 11c, and transmit signals from the cell monitoring ICs 11a, 11b and 11c to the output connectors 13a, 13b and 13c under the electrical insulation state (or the electrical isolation state).

Each of the input side opto-isolation elements 14a, 14b and 14c receives the input signal at the low voltage section of each of the monitoring units 10a, 10b and 10c, converts the input signal to a signal to be used in the high voltage section, and transmits the signal to each of the cell monitoring ICs 11a, 11b and 11c located in the high voltage section. Each of the cell monitoring ICs 11a, 11b and 11c located in the high voltage side outputs the signal. Each of the opto-isolation elements 15a,15b and 15c converts the received signal to a signal to be used in the low voltage section. The monitoring units 10a, 10b and 10c transmit the signal at the low voltage section to the input connector 12b of the monitoring unit 10b and the input connector 12c of the monitoring unit 10c, and the input connector 23 of the control unit 20, respectively. This structure of the monitoring device according to the exemplary embodiment makes it possible to prevent a high voltage supplied from the cell monitoring ICs 11a, 11b and 11c to the input connectors 12a, 12b and 12c and the output connector 13a, 13b and 13c.

The input side opto-isolation elements 1a, 14b and 14c (input side isolation elements) are mounted on the substrates 17a, 17b and 17c and arranged between the input connectors 12a, 12b and 12c and the cell monitoring ICs 11a, 11b and 11c, respectively.

Through the input side opto-isolation elements 14a, 14b and 14c, the signals are transmitted from the input signal lines connected to the input connectors 12a, 12b and 12c to the cell monitoring ICs 11a, 11b and 11c, respectively under the electrical isolation state. The exemplary embodiment uses photocouplers as the input side opto-isolation elements 14a, 14b and 14c. Each of the input side opto-isolation elements 14a, 14b and 14c has a photo diode which is driven by a 5 volt power source and mounted in the low voltage section of each of the substrates 17a, 17b and 17c, respectively. Each of the input side opto-isolation elements 14a, 14b and 14c further has a photo transistor which is driven by a high voltage power source FB1, FB2, FB3 and mounted in each of the high voltage section of the substrates 17a, 17b and 17c, respectively. It is accordingly possible to transmit the signals from the input connectors 12a, 12b and 12c in the low voltage section in the substrates 17a, 167b and 17c to the cell monitoring ICs 11a, 11b and 11c under the electrically isolation state.

The output side opto-isolation elements 15a, 15b and 15c (which correspond to output side isolation elements) are mounted on the substrates 17a, 17b and 17c, respectively, and between the cell monitoring ICs 11a, 11b and 11c and the output connectors 13a, 13b and 13c, respectively. Through the output side opto-isolation elements 15a, 15b and 15c, the signals are transmitted from the cell monitoring ICs 11a, 11b and 11c to the output signal lines connected to the output connectors13a, 13b and 13c, respectively under the electrical insulation state (or the electrical isolation state). Similar to the input side opto-isolation elements 14a, 14b and 14c, the exemplary embodiment uses photocouplers as the output side opto-isolation elements 15a, 15b and 15c.

The photo diode in each of the photocouplers as the opto-isolation elements 14a, 14b, 14c, 15a, 15b and 15c is mounted in the high voltage side of the substrates 17a, 17b and 17c and driven by a high voltage of the power sources FB1, Fb2 and Fb3.

On the other hand, the photo transistor in each of the photocouplers as the opto-isolation elements 14a, 14b, 14c, 15a, 15b and 15c is mounted in the low voltage side of the substrates 17a, 17b and 17c and driven by a 5 V low voltage power source. Accordingly, the output side opto-isolation elements 15a, 15b and 15c transmit the signals from the cell monitoring ICs 11a, 11b and 11c in the high voltage section to the output connectors 13a, 13b and 13c under the electrical insulation state (or the electrical isolation state).

The buffer elements 16a, 16b and 16c are mounted on the substrates 17a, 17b and 17c, respectively. In more detail, the buffer elements 16a, 16b and 16c are arranged in the low voltage section and between the output side opto-isolation elements 15a, 15b and 15c and the output connectors 13a, 13b and 13c, respectively.

Each of the buffer elements 16a, 16b and 16c is a transistor, for example. The buffer elements 16a, 16b and 16c receive signals transmitted from the output side opto-isolation elements 15a, 15b and 15c, and amplify the received signals, and output the amplified signals to the output connectors 13a, 13b and 13c, respectively.

When each of the cell monitoring ICs 11a, 11b and 11c, the input side opto-isolation elements 14a, 14b and 14c, and the output side opto-isolation elements 15a, 15b and 15c outputs an inverse signal of the received input signal having a low level or a high level, the buffer elements 16a, 16b and 16c have a function of outputting an inverse signal of an input signal. For example, this structure allows the cell monitoring IC 11b to receive the signal of a low level when the cell monitoring IC 11a outputs a signal having a high level.

When the microcomputer 21 generates and outputs a monitoring instruction signal, the cell monitoring IC 11a received the start instruction signal through the output connector 22 of the control unit 20 and the input side opto-isolation element 14a. Further, the cell monitoring IC 11a outputs the monitoring instruction signal is transmitted to the cell monitoring IC 11b through the output side opto-isolation element 15a, the buffer element 16a, the output connector 13a, the input connector 12b and the input side opto-isolation element 14b.

Still further, the cell monitoring IC 11b outputs the monitoring instruction signal to the cell monitoring IC 11c through the output side opto-isolation element 15b, the buffer element 16b, the output connector 13b, the input connector 12c and the input side opto-isolation element 14c. As previously described in detail, the monitoring instruction signal outputted from the microcomputer 21 is transmitted to the cell monitoring ICs 11a, 11b and 11c by a daisy chain communication using the daisy chain connection.

The cell monitoring IC 11a transmits a detected voltage signal to the cell monitoring IC 11b and the cell monitoring IC 11c, sequentially. Further, the detected voltage signal is transmitted from the cell monitoring IC 11c to the microcomputer 21 through the output side opto-isolation element 15c, the buffer element 16c, the output connector 13c and the input connector 23 of the control unit 20.

Similarly, the cell monitoring IC 11b transmits a detected voltage signal to the cell monitoring IC 11c. Further, the detected voltage signal is transmitted from the cell monitoring IC 11c to the microcomputer 21 through the output side opto-isolation element 15c, the buffer element 16c, the output connector 13c and the input connector 23 of the control unit 20.

Furthermore, the cell monitoring IC 11c transmits a detected voltage signal to the microcomputer 21 through the output side opto-isolation element 15c, the buffer element 16c, the output connector 13c and the input connector 23 of the control unit 20.

As previously described, the detected voltage signals obtained by the cell monitoring ICs 11a, 11b and 11c are transmitted to the microcomputer 21 by the daisy chain communication using the daisy chain connection.

A description will now be given of the effects of the monitoring units 10a, 10b and 10c and the monitoring device according to the exemplary embodiment having the structure previously described.

In the structure of the monitoring device according to the exemplary embodiment shown in FIG. 1, the cell monitoring ICs 11a, 11b and 11c are isolated and insulated from the input connectors 12a, 12b and 12c through the input side opto-isolation elements 14a, 14b and 14c, respectively. Further, the cell monitoring ICs 11a, 11b and 11c are isolated from the output connectors 13a, 13b and 13c through the input side opto-isolation elements 14a, 14b and 14c, respectively. Because this structure prevents a high voltage of the cell monitoring ICs 11a, 11b and 11c from being supplied to the input connectors 12a, 12b and 12c and the output connectors 13a, 13b and 13c, it is possible to prevent danger of electric shock when an operator or a worker touches these connectors in order to connect the monitoring units 10a, 10b and 10c and the control unit 20 together or disconnect one monitoring unit from the other monitoring units and the control unit 20.

The output connector 13a of the monitoring unit 10a is connected to the input connector 12b of the monitoring unit 10b. The output connector 13b of the monitoring unit 10b is connected to the input connector 12c of the monitoring unit 10c. This connection makes it possible to transmit the signals sequentially from the cell monitoring IC 11a in the monitoring unit 10a to the cell monitoring IC 11b in the monitoring unit 10b, and from the cell monitoring IC 11b in the monitoring unit 10b to the cell monitoring IC 11c in the monitoring unit 10c, through the output side opto-isolation elements 15a and 15b, the input side opto-isolation elements 14b and 14c, the output connectors 13a and 13b, the input connectors 12b and 12c.

Further, the output connector 22 of the control unit 20 is connected to the input connector 12a of the monitoring unit 10a. This connection structure makes it possible for the microcomputer 21 to the cell monitoring IC 11a of the monitoring unit 10a through the output connector 22 of the control unit 20, the input connector 12a and the input side opto-isolation element 14a.

The output connector 13c of the monitoring unit 10c is connected to the input connector 23 of the control unit 20. This connection structure makes it possible to transmit the signals to the microcomputer 21 from the cell monitoring IC 11c of the monitoring unit 10c through the output side opto-isolation element 15c, the buffer element 16c, the output connector 13c and the input connector 23 of the control unit 20. This connection makes it possible to perform a daisy chain communication between the microcomputer 21 and the cell monitoring ICs 11a, 11b and 11c.

Even if the input side opto-isolation elements 14a, 14b and 14c and the output side opto-isolation elements 15a, 15b and 15c limit a signal level of detection signals, it is possible to amplify the detection signals by adding the buffer elements 16a, 16b and 16c which are inexpensive and available in the commercial market.

Further, because the buffer elements 16a, 16b and 16c are arranged between the output side opto-isolation elements 15a, 15b and 15c and the output connectors 13a, 13b and 13c, respectively, the amplified detection signals can be transmitted to the other substrate This structure makes it possible to increase noise resistance generated between the substrates.

As previously described in detail, it is possible to isolate the high voltage section from the low voltage section in the monitoring device by adding the photocouplers as the input side opto-isolation elements 14a, 14b and 14c and the output side opto-isolation elements 15a, 15b and 15c. This structure makes it possible to have a long life time and a reduced size and inexpensive manufacturing cost when compared with an electrical insulation and isolation structure using electromagnetic relays, etc.

### (Other Modifications)

A description will now be given of structural modifications of the monitoring device according to the exemplary embodiment with reference to FIG. 2 and FIG. 3.

In a modification of the structure of the monitoring device according to the exemplary embodiment, it is possible to use capacitances instead of the input side opto-isolation elements 14a, 14b and 14c, and the output side opto-isolation elements 15a, 15b and 15c which are used in the monitoring units 10a, 10b and 10c in the monitoring device shown in FIG. 1. This structure makes it possible to transmit signals between the cell monitoring ICs 11a, 11b and 11c and the microcomputer 21 through the input connectors and the output connectors under the state in which the cell monitoring ICs 11a, 11b and 11c are isolated and electrically insulated from the input connectors and the output connectors and it is possible to prevent occurrence of danger of electric shock when an operator or a worker touches these connectors in order to connect the monitoring units 10a, 10b and 10c and the control unit 20 together or disconnect one monitoring unit from the other monitoring units and the control unit 20.

Further, it is possible to use a combination of the opto-isolation elements and the capacitors. That is, it is possible to arrange one of the opto-isolation element and the capacitor between the cell monitoring ICs 11a, 11b and 11c and the input connectors 12a, 12b and 12c, and between the cell monitoring ICs 11a, 11b and 11c and the output connectors 13a, 13b and 13c.

FIG. 2 is a view showing another structural modification of the monitoring unit equipped with the cell monitoring IC in the monitoring device according to the exemplary embodiment of the present invention. As shown in FIG. 2, it is acceptable to arrange a buffer element 16 between an input connector 12 and an input side opto-isolation element 14 on a substrate 17 instead of a structure in which the buffer element is arranged between an output connector 13 and an output side opto-isolation element 15. The structural arrangement shown in FIG. 2 has a noise resistance which is slightly lower than the noise resistance shown in FIG. 1.

FIG. 3 is a view showing another structural modification of the monitoring unit equipped with the cell monitoring IC in the monitoring device according to the exemplary embodiment of the present invention. As shown in FIG. 3, it is acceptable for the monitoring unit 50 to a structure having no buffer element in the substrate 17. That is, the buffer element has been removed from the structure of the monitoring unit 40 shown in FIG. 2. This structure shown in FIG. 3 can be applied to low noise circumstances.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A monitoring unit capable of monitoring a state of a battery pack, comprising:
a substrate comprising a high voltage section and a low voltage section;
a battery state detection section mounted in the high voltage side of the substrate and configured to detect a state of the battery pack comprising a plurality of battery cells;
an input side connection and disconnection section mounted in the low voltage section of the substrate and configured to connect an input signal line to an outside signal line, and disconnect the input signal line from the outside signal line, the battery state detection sections receiving an input signal through the input signal line, and the outside signal line being arranged outside of the substrate;
an output side connection and disconnection section mounted in the low voltage section of the substrate and configured to connect an output signal line to the outside signal line and disconnect the output signal line from the outside signal line, the battery state detection section outputting an output signal to the outside signal line through the output signal line;
an input side isolation element mounted on the substrate and configured to transmit the input signal from the input signal line to the battery state detection section under an electrical insulation state; and
an output side isolation element mounted on the substrate and configured to transmit the output signal from the battery state detection section to the output signal line under the electrical insulation state.

2. A monitoring device which monitors a state of a battery pack, comprising a plurality of the monitoring units, each of the monitoring units being claimed in claim 1,
wherein the output side connection and disconnection section of a first monitoring unit is connected to the input side connection and disconnection section of a second monitoring unit when the first monitoring unit and the second monitoring unit are selected from the monitoring units.

3. A monitoring device which monitors a state of a battery pack, comprising:
a plurality of the monitoring units according to claim 1;
a control substrate;
a control section mounted on the control substrate and configured to generate and transmit a signal to the battery state detection section; and
an output control connection and disconnection section mounted in the control substrate and configured to connect an output control signal line of the control substrate to an outside signal line of the control substrate and disconnect the output control signal line from the outside signal line of the control substrate,
wherein the input side connection and disconnection section of the monitoring unit is connected to the output control connection and disconnection section.

4. A monitoring device which monitors a state of a battery pack, comprising:
a plurality of the monitoring units according to claim 1;
a control substrate;
a control section mounted on the control substrate and configured to receive a signal transmitted from the battery state detection section; and
an input control connection and disconnection section mounted in the control substrate and configured to connect an input control signal line of the control substrate to an outside signal line of the control substrate, and disconnect the input control signal line from the outside signal line of the control substrate,
wherein the output side connection and disconnection section of the monitoring unit is connected to the input control connection and disconnection section.

5. The monitoring device which monitors a state of a battery pack, according to claim 1, further comprising at least a buffer element configured to amplify the output signal transmitted from the output side isolation element and output the amplified output signal to the output side connection and disconnection section.

6. The monitoring device which monitors a state of a battery pack, according to claim 1, wherein each of the input side isolation element and the output side isolation element is one selected from a photocoupler and a capacitor.

7. A monitoring device which monitors a state of a battery pack, comprising:
a plurality of the monitoring units according to claim 2;
a control substrate;
a control section mounted on the control substrate and configured to generate and transmit a signal to the battery state detection section; and
an output control connection and disconnection section mounted in the control substrate and configured to connect an output control signal line of the control substrate to an outside signal line of the control substrate and disconnect the output control signal line from the outside signal line of the control substrate,
wherein the input side connection and disconnection section of the monitoring unit is connected to the output control connection and disconnection section.

8. The monitoring device which monitors a state of a battery pack, comprising:
a plurality of the monitoring units according to claim 2;
a control substrate;
a control section mounted on the control substrate and configured to receive a signal transmitted from the battery state detection section; and
an input control connection and disconnection section mounted in the control substrate and configured to connect an input control signal line of the control substrate to an outside signal line of the control substrate, and disconnect the input control signal line from the outside signal line of the control substrate,
wherein the output side connection and disconnection section of the monitoring unit is connected to the input control connection and disconnection section.

9. The monitoring device which monitors a state of a battery pack, according to claim 2, further comprising at least a buffer element configured to amplify the output signal transmitted from the output side isolation element and output the amplified output signal to the output side connection and disconnection section.

10. The monitoring device which monitors a state of a battery pack, according to claim 2, wherein each of the input side isolation element and the output side isolation element is one selected from a photocoupler and a capacitor.
